(19) United States
(12) Patent Application Publication
(10) Pub. No.: US 2006/0105152 A1
(43) Pub. Date: May 18, 2006

(54) Flexible sheet for resistive touch screen

(75) Inventors: Ronald S. Cok, Rochester, NY (US); Debasis Majumdar, Rochester, NY (US); Glen C. Irvin JR., Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/986,968

(22) Filed: Nov. 12, 2004

(51) Int. Cl. B32B 3/00; B32B 18/00; B05D 5/12

(52) U.S. Cl. 428/209; 428/210; 427/58; 428/917

(57) ABSTRACT

A resistive touch screen, comprising: a) a substrate; b) a first conductive layer located on the substrate; c) a flexible cover sheet comprising a substantially planar surface and integral compressible spacer dots formed thereon, each integral compressible spacer dot having a base closest to the planar surface and a peak furthest from the planar surface, with a microstructured surface on the peak of each of the integral compressible spacer dots; and d) a second conductive layer located on the flexible cover sheet, the peaks of the integral compressible spacer dots extending through the second conductive layer, whereby, when a force is applied to the flexible transparent cover sheet at the location of one of the compressible spacer dots, the compressible spacer dot is compressed to allow electrical contact between the first and second conductive layers.

### FIELD OF THE INVENTION

This invention relates to resistive touch screens and more particularly, to a flexible cover sheet and spacer dots separating the cover sheet from a substrate in a resistive touch screen.

### BACKGROUND OF THE INVENTION

Resistive touch screens are widely used in conventional CRTs and in flat-panel display devices in computers and in particular with portable computers.

FIG. 3 shows a portion of a prior-art resistive touch screen 10 of the type shown in Published US Patent Application No. 2002/0094660A1, filed by Getz et al., Sep. 17, 2001, and published Jul. 18, 2002, which includes a rigid transparent substrate 12, having a first conductive layer 14. A flexible transparent cover sheet 16 includes a second conductive layer 18 that is physically separated from the first conductive layer 14 by spacer dots 20 formed on the second conductive layer 18 by screen printing.

Referring to FIG. 4, when the flexible transparent cover sheet 16 is deformed, for example by finger 13 pressure, to cause the first and second conductive layers to come into electrical contact, a voltage applied across the conductive layers 14 and 18 results in a flow of current proportional to the location of the contact. The conductive layers 14 and 18 have a resistance selected to optimize power usage and position sensing accuracy. The magnitude of this current is measured through connectors (not shown) connected to metal conductive patterns (not shown) formed on the edges of conductive layers 18 and 14 to locate the position of the deforming object.

Alternatively, it is known to form the spacer dots 20 for example by spraying through a mask or pneumatically sputtering small diameter transparent glass or polymer particles, as described in U.S. Pat. No. 5,062,198 issued to Sun, Nov. 5, 1991. The transparent glass or polymer particles are typically 45 microns in diameter or less and mixed with a transparent polymer adhesive in a volatile solvent before application. This process is relatively complex and expensive and the use of an additional material such as an adhesive can be expected to diminish the clarity of the touch screen. Such prior-art spacer dots are limited in materials selections to polymers that can be manufactured into small beads or UV coated from monomers.

It is also known to use photolithography to form the spacer dots 20. In these prior-art methods, the spacer dots may come loose and move around within the device, thereby causing unintended or inconsistent actuations. Furthermore, contact between the conductive layers 14 and 18 is not possible where the spacer dots are located, thereby reducing the accuracy of the touch screen. Stress at the locations of the spacer dots can also cause device failure after a number of actuations. Unless steps are taken to adjust the index of refraction of the spacer dots, they can also be visible to a user, thereby reducing the quality of a display located behind the touch screen.

U.S. Pat. No. 4,220,815 (Gibson et al.) and US Patent Application US20040090426 (Bourdelais et al.) disclose integral spacer dots on flexible cover sheets for touch screen applications. However, integral spacer dots must not have their top surfaces coated with the conductive layer to avoid electrical shorts between the first and second conductive layers, 14 and 18. US20040090426 addresses such need by high energy treatment (corona discharge treatment or glow discharge treatment) of the peaks of the spacer beads to provide surface energy difference to allow for differential surface wetting of an applied conductive layer, or by scraping of an applied conductive layer from the peaks of the spacer dots. In U.S. Pat. No. 4,220,815, cover sheet is provided with insulator islands created by deforming the cover sheet against a resilient surface with a punch. The force exerted by the punch destroys the conductive layer coated on the other side of the cover sheet. Each insulating island is associated with a corresponding dimple in the upper surface of cover sheet. Such requirements add complexity to the manufacturing process, and may negatively impact yields. Further, these approaches may not adequately electrically isolate the insulating islands, and will have reduced lifetime due to stresses induced in the cover sheet. Moreover, the dimples on the back side of the cover sheet are objectionable or, if filled, require additional materials and manufacturing steps to fill.

There is a need therefore for an improved means to separate the conductive layers of a touch screen and a method of making the same that improves the robustness of the touch screen and reduces the cost of manufacture.

### SUMMARY OF THE INVENTION

In one embodiment, the invention is directed towards a resistive touch screen, comprising: a) a substrate; b) a first conductive layer located on the substrate; c) a flexible cover sheet comprising a substantially planar surface and integral compressible spacer dots formed thereon, each integral compressible spacer dot having a base closest to the planar surface and a peak furthest from the planar surface, with a microstructured surface on the peak of each of the integral compressible spacer dots; and d) a second conductive layer located on the flexible cover sheet, the peaks of the integral compressible spacer dots extending through the second conductive layer, whereby, when a force is applied to the flexible transparent cover sheet at the location of one of the compressible spacer dots, the compressible spacer dot is compressed to allow electrical contact between the first and second conductive layers.

In a further embodiment, the invention is directed towards a method of making a resistive touch screen, comprising the steps of: a) providing a substrate; b) forming a first conductive layer on the substrate; c) providing a flexible cover sheet comprising a substantially planar surface and integral compressible spacer dots formed thereon, each integral compressible spacer dot having a base closest to the planar surface and a peak furthest from the planar surface, with a microstructured surface on the peak of each of the integral compressible spacer dots; d) forming a second conductive layer on the flexible cover sheet between the integral compressible spacer dots by coating a conductive material over the flexible cover sheet such that the microstructured surface of the integral compressible spacer dot peaks do not wet and are not covered with the second conductive layer; and e) locating the flexible cover sheet over the substrate such that when a force is applied to the flexible cover sheet at the location of one of the integral compressible spacer dots, the integral compressible spacer dot is compressed to allow electrical contact between the first and second conductive layers.

### Advantages

The touch screen of the present invention has the advantages that it is simple to manufacture, and provides greater accuracy, robustness, and clarity.

### BRIEF DESCRIPTION OF THE DRAWINGS

FIG. 1 is a schematic diagram showing a portion of a touch screen according to one embodiment of the present invention;

FIG. 2 is a schematic diagram illustrating the operation of the touch screen shown in FIG. 1;

FIG. 3 is a schematic diagram showing a portion of a prior-art touch screen;

FIG. 4 is a schematic diagram illustrating the operation of the prior-art touch screen of FIG. 3;

FIG. 5 is a diagram illustrating one of the integral spacer dots according to the present invention;

FIG. 6 is a schematic diagram illustrating one method of making a touch screen according to the present invention;

FIG. 7 is a diagram illustrating one of the integral spacer dots having microstuctures according to an embodiment of the present invention;

FIG. 8 is a side-view of a resistive touch screen of an embodiment of the present invention integrated with a bottom-emitting flat-panel display; and

FIG. 9 is a side-view of a resistive touch screen of an embodiment of the present invention integrated with a top-emitting flat-panel.

### DETAILED DESCRIPTION OF THE INVENTION

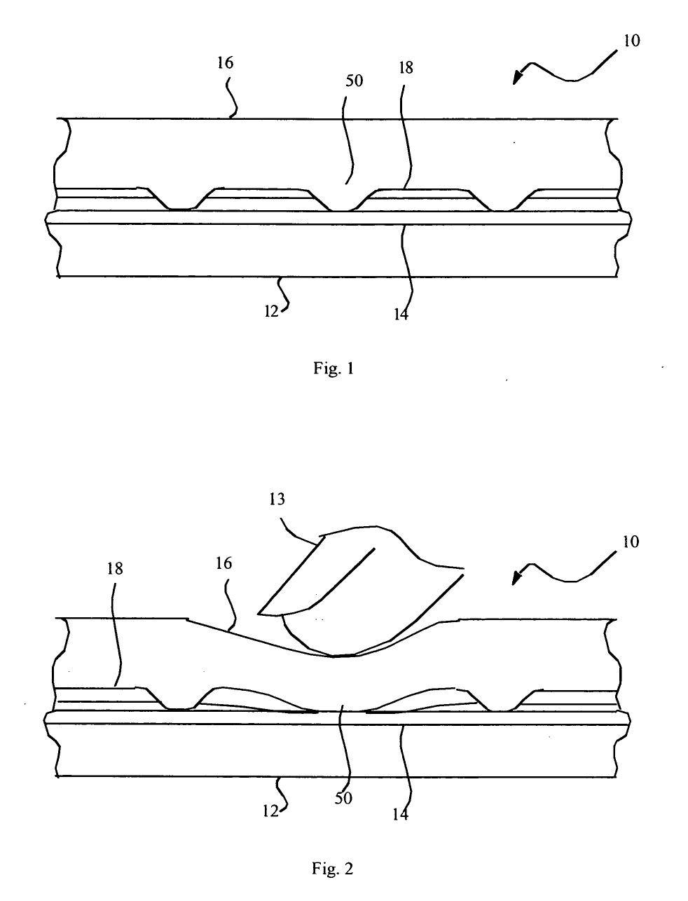

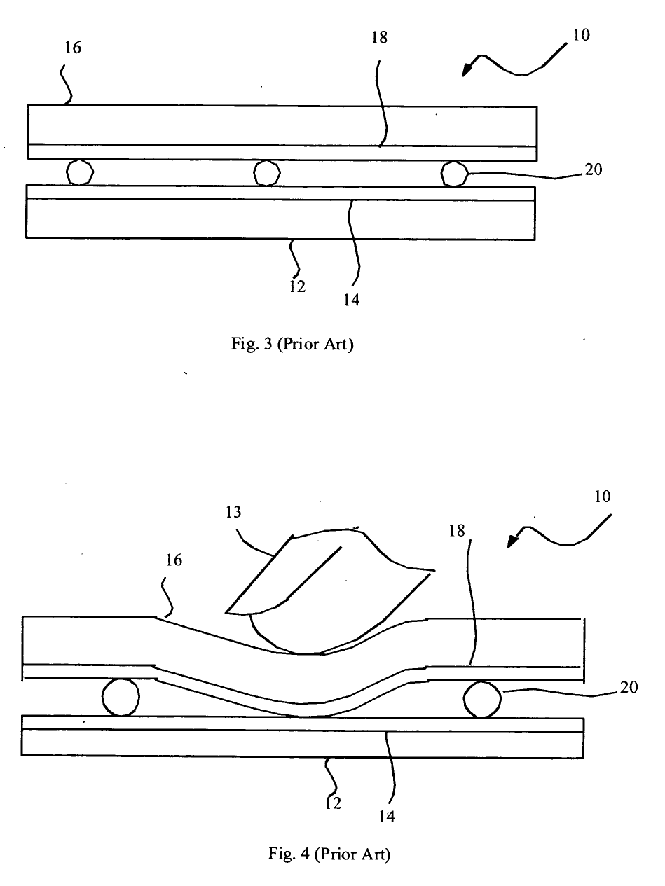

Referring to FIG. 1, the problems of the prior-art resistive touch screens are overcome through the use of a flexible cover sheet 16 having a second conductive layer 18 and integral compressible spacer dots 50 formed in the flexible cover sheet 16. Flexible cover sheet 16 comprises a substantially planar surface and the integral compressible spacer dots 50 are formed thereon, each integral compressible spacer dot having a base closest to the planar surface and a peak furthest from the planar surface. Each integral compressible spacer dot 50 has a microstructured surface on the peak. A second conductive layer 18 is coated over the flexible transparent cover sheet 16 between the spacer dots 50, but does not cover the peaks of the integral compressible spacer dots 50. The peaks of the integral compressible spacer dots 50 extend through the second conductive layer 18, whereby, when a force is applied to the flexible cover sheet 16 at the location of one of the integral compressible spacer dots 50, the integral compressible spacer dot is compressed to allow electrical contact between the first and second conductive layers. The word “integral” means that the compressible spacer dots 50 are formed in and comprise the same material as the flexible cover sheet 16 for example by molding or embossing.

The integral compressible spacer dots 50 prevent the second conductive layer 18 deposited on the flexible cover sheet 16 from touching the first conductive layer 14 on the substrate 12. Because the peaks of the second conductive layer 18 in the region of the integral compressible spacer dots 50 are not coated with a conductor and because the integral compressible spacer dots 50 physically separate the conductive regions of layer 18 and conductive layer 14, no current can flow between the conductive layers. While the various layers of the touch screen may be transparent or not for different applications, in a preferred embodiment each of the substrate, first conductive layer, flexible cover sheet, and second conductive layer are transparent to allow use in combination with displays.

Referring to FIG. 2, in operation, when an external object such as a finger 13 or stylus deforms the flexible cover sheet 16, the flexible cover sheet 16 is pressed against the substrate 12 thereby causing the conductive layer 14 and conductive layer 18 to touch and close a circuit. Substrate 12 itself may be rigid or flexible. If the substrate is flexible, however, it should be less flexible than the cover sheet, or mounted upon a surface that is less flexible than the cover sheet. If the deformation occurs on one of the integral compressible spacer dots 50 (as shown), the spacer dot is compressed so that contact is made between conductive layer 14 and conductive regions of layer 18 and current can flow between the conductive layers. Since the stylus or finger 13 is typically larger than the integral compressible spacer dot 50, the lack of conductive material at the top of the integral compressible spacer dot 50 does not inhibit the conductive layers 14 and 18 from touching.

Because the integral compressible spacer dots 50 are an integral part of the flexible cover sheet 16, they are fixed imposition and cannot move or come loose as can spacer dots composed of beads in an adhesive matrix, or dots that are formed by printing or photolithography. Moreover, the integral spacer dots can be smaller than conventional spacer dots (e.g. as small as 1 micron in diameter, usually 10 to 50 microns). Additional materials, such as adhesives, are unnecessary, thereby reducing manufacturing materials and steps and further improving the optical clarity of the device.

There are at least two methods for creating the integral compressible spacer dots integral to the flexible cover sheet. The first is to take an existing, formed flexible cover sheet with no spacer dots and emboss spacer dots in the flexible cover sheet by applying heat and pressure to the flexible cover sheet in a mold that defines a reverse image of the spacer dots. The heat and pressure reforms the flexible cover sheet so that the flexible cover sheet will have integral compressible spacer dots when the mold is removed. Such a mold can be, for example, a cylinder that rolls over a continuous sheet of flexible cover sheet material. In a second method, melted polymer may be coated over the mold and forced into the cavities (for example by injection roll molding), allowed to cool, and then lifted from the mold. The mold may be provided with the cavities through conventional means, for example machining, bead blasting or etching. Electromechanical engraving and fast-tool servo processes which may be used to form a patterned cylinder mold for use in the present invention are also described in copending, commonly assigned U.S. Ser. No. ______ (Kodak Docket number 87740, filed concurrently herewith), the disclosure of which is hereby incorporated by reference. The base of the dot 50 (where it is connected to the sheet 16) may be the maximum size of the spacer dot to facilitate the extraction of the shaped material from the mold. The molding process may be continuous roll molding.

With either method, a great variety of spacer dot shapes are possible, for example, cylinders, cubes, spheres, hemispheres, cones and pyramids. The spacer dot shape is dependent on a number of considerations, for example, the method used for manufacturing, the size of the object used to deform the cover sheet, the size of the dots, the flexible cover sheet material, and the number of activations of the device over its useable lifetime.

In one embodiment of the invention, the integral compressible spacer dots of the invention may have a roughly flat-topped circularly cylindrical shape. A circular cylinder provides for specular light transmission and has impact resistance. Further, the ends of the cylinders can provide excellent optical contact with the substrate. The diameter and height of the cylinders can be adjusted to provide the desired compression profile. As used herein compression profile means the ability of the spacer dots to undergo the desired compression and expansion.

In another embodiment of the invention, the integral compressible spacer dots may be hemisphere-shaped. The hemisphere provides a precision gap as well as high light transmission. The hemisphere also provides excellent compression and fatigue characteristics. In another embodiment of the invention, the integral compressible spacer dots may be cylinder-shaped having rectangular cross sections. A rectangular compressible spacer dot (for example a cube) provides impact resistance as well as a precision optical spacing. In another embodiment, the integral compressible spacer dot may comprise a pyramid shape, which may have a flat top. A pyramid provides a precision optical gap as well as some light directing. A 45-degree pyramid in air will tend to focus transmitted light into a line perpendicular to the base of the pyramid providing both optical spacing as well as light directing. Further, the pyramid and hemisphere shapes provide a more rapidly changing compression gradient as the shape is compressed.

The flexible cover sheet having the integral compressible spacer dots is preferably constructed from a polymer. In certain embodiments, a transparent flexible cover sheet may be desired, particularly in combination with touch screen devices comprising transparent substrates. A transparent polymeric material may provide high light transmission properties, is inexpensive and a sheet of polymeric material can easily be formed with integral compressible spacer dots. Suitable polymer materials include polyolefins, polyesters, polyamides, polycarbonates, cellulosic esters, polystyrene, polyvinyl resins, polysulfonamides, polyethers, polyimides, polyvinylidene chloride, polyethers, polyvinylidene fluoride, polyurethanes, polyphenylenesulfides, polytetrafluoroethylene, polyacetals, polysulfonates, polyester ionomers, and polyolefin ionomers as well as copolymers and blends thereof. Polycarbonate polymers have high light transmission and strength properties. Copolymers and/or mixtures of these polymers can be used.

Polyolefins particularly polypropylene, polyethylene, polymethylpentene, and mixtures thereof are suitable. Polyolefin copolymers, including copolymers of propylene and ethylene such as hexene, butene and octene can also be used. Polyolefin polymers are suitable because they are low in cost and have good strength and surface properties and have been shown to be soft and scratch resistant.

The polymeric materials used to make flexible transparent cover sheet in preferred embodiments of this invention preferably have a light transmission greater than 92%. A polymeric material having an elastic modulus greater than 500 MPa is suitable. An elastic modulus greater than 500 MPa allows for the integral compressible spacer dots to withstand the compressive forces common to touch screens. Further, an elastic modulus greater than 500 MPa allows for efficient assembly of a touch screen as the dots are tough and scratch resistant.

A spacer dot integral to the flexible cover sheet significantly reduces unwanted reflection from an optical surface such as those present in prior art touch screens that utilize polymer beads. An integral spacer dot also provides for superior durability as the dot location is fixed in the flexible cover sheet of the invention and is not subject to movement during vibration or extended use. The integral compressible spacer dots of the invention preferably have heights between 2 and 100 micrometers, more preferably between 2 and 50 micrometers, and most preferably between 10 and 50 micrometers, although shorter or taller spacer dots might be desired in some applications. The height of the spacer dot should put enough distance between the top of the spacer dot and the conductive coating on the substrate so that inadvertent electrical contact between conductive coating on the substrate and the conductive coating on the flexible sheet can be avoided, at least when no touch is applied to the touch screen. In particular, the height should be at least somewhat greater than the size of possible asperities or other defects in the conductive coating(s) that could potentially bridge the gap if the spacer dots were not tall enough. In general, larger height of the spacer dots means a lower probability of inadvertent electrical contact and a higher actuation force. A height less than 10 micrometers, and in particular less than 2 micrometers, may not provide sufficient spacing for the two conductive layers resulting in false actuation. A height greater than 50 micrometers, and in particular greater than 100 micrometers, separating the layers may require too high a compression force to connect the two conductive layers and thus may be problematic.

A desired maximum diameter for the spacer dots generally depends on their heights, so that the ratio of height to diameter is often the relevant quantity, although the absolute value of the diameter may also be important. Dots having a smaller diameter may be less visible to a user. Dots having a smaller diameter may also lead to better electronic performance of the touch panel due to less total area coverage of the spacer dots. Very large dots may decrease touch screen resolution and/or increase the activation force. In illustrative cases, spacer dot maximum diameters may be in the range of 1 to 60 micrometers, although smaller or larger spacer dots might be desired in some applications. In some embodiments, the spacer dots preferably have height to width ratios of between 0.5 and 3.0. It has been found that this range of aspect ratios enables long lasting touch screen spacer dots that are compressible and durable.

The integral compressible spacer dots preferably are spaced apart by a distance of greater than 0.25 millimeter, more preferably greater than 1 millimeter. Spacing less than 0.25 millimeter may require compressive forces that are too high to achieve contact between the two conductive layers. The polymer and dot profile used for the flexible cover sheet with integral compressible spacer dots according to this invention preferably provide for elastic deformation of greater than 1 million actuations. Elastic deformation is the mechanical property of the spacer dot to recover at least 95% of its original height after an actuation. High-quality touch screens are also required to have a consistent actuation force over the useful lifetime of the device. Spacer dot fatigue can result in increasing actuation forces over the lifetime of the device, resulting in scratching of the surface of the touch screen and user frustration.

A variety of polymeric materials, inorganic additives, layered swellable materials having a high aspect ratio wherein the size of the materials in one dimension is substantially smaller than the size of the materials in the other dimensions, organic ions and agents serving to intercalate or exfoliate the layer materials such as block copolymers or an ethoxylated alcohols, smectite clays, nanocomposite materials, and means to form the flexible cover sheet and integral spacer dots are described in US Patent Application US20040090426, which is hereby incorporated by reference.

The size, shape, height, locations and spacing of compressible spacer dots can be chosen to meet the pressure and reliability usage specification of a particular application. The locations may form a pattern or may be random. Having the spacer dots vary in shape and/or spacing creates a touch screen that has varying levels of sensitivity, accuracy, and durability across the touch screen to tailor each area of the touch screen to its application. For example, the profile of the embossing can vary to complement a variety of flexible cover sheet materials so as to maximize the lifetime, clarity, and physical properties of the flexible cover sheet. In certain embodiments, it may desirable to size and position the integral compressible spacer dots in a pattern that establishes at least one of differentiated minimum required activation forces and differentiated durability for selected areas of the touch screen as described in copending, commonly assigned U.S. Ser. No. ______ (Kodak Docket 87618, filed concurrently herewith), the disclosure of which is incorporated by reference herein.

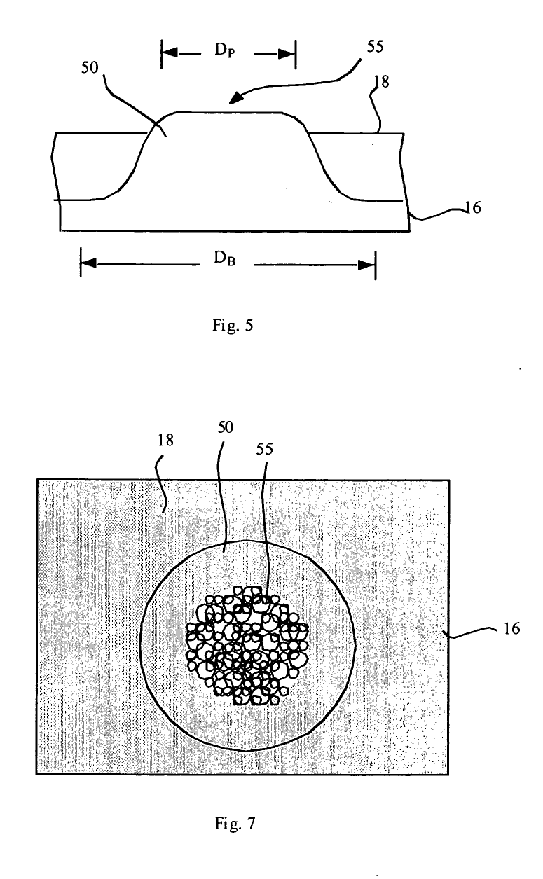

Referring to FIG. 5, the profile of a truncated conical spacer dot 50 that has a base diameter D_{b} that is 75% larger than the peak diameter Dₚ is shown integral to the flexible cover sheet 16 together with a coated conductive layer 18. This geometry has been shown to provide an excellent compression profile allowing moderate levels of compressive force applied by the user to activate the touch screen. The base diameter being 75% larger than the peak diameter provides mechanical toughness, reduces dot wear and provides for over 1 million actuations before a 5% loss in height. A suitable material for the compressive dot illustrated in FIG. 5 is a blend of polyester and polycarbonate where the polycarbonate is present in the amount of 10% by weight of the polyester.

Referring to FIG. 6, in a preferred embodiment of the present invention, the integral spacer dots having microstructured peak surfaces and flexible cover sheet are injection roll molded as a single unit. In the injection roll molding process a polymer 82 is heated above its melting point, and is injected under pressure into a nip 86 formed by a patterned roller 80 and an elastomer covered backing roller 84 in direct contact with the patterned roller 80. The patterned roller 80 has a pattern of cavities for forming the integral spacer dots with microstructured peak surfaces. As the polymer is injected into the nip 86, some of the melted polymer fills the cavities of the patterned roller to form the integral spacer dots and the balance of the polymer is squeezed into a flat sheet having the integral spacer dots. After the integral spacer dots and flexible cover sheet have been formed, the flexible cover sheet with integral spacer dots is mechanically released from both of the rollers.

The pattern of cavities in patterned roller 80 for forming the integral compressible spacer dots may include at the bottom of each cavity, a microstructured fractal surface having self-similar structures at a variety of different sizes. Such fractal surfaces are known to affect the wetting properties of the surface and may be constructed to prevent the wetting of the surface of any material molded from the patterned roller 80. For example, US20020084290A1 entitled “Method and apparatus for dispensing small volume of liquid, such as with a wetting-resistant nozzle” by Materna, et al published 20020704 describes a wetting-resistant nozzle for accurately and precisely dispensing small volumes of liquids and describes the use of surface roughness to increase the hydrophobic character of the surface. When the polymer is molded, the integral compressible spacer dots will have the reverse feature of the mold, thereby acquiring a micro-replicated structure that controls the wettability of the dots. Means for creating such molds are known and described in, for example, U.S. Pat. No. 6,641,767 B2 entitled “Methods for replication, replicated articles, and replication tools” by Zhang et al, issued 20031104. U.S. Pat. No. 6,641,767B2 describes a method of replicating a structured surface that includes providing a tool having a structured surface having a surface morphology of a crystallized vapor deposited material; and replicating the structured surface of the tool to form a replicated article. A replicated article includes at least one replicated surface, wherein the replicated surface includes a replica of a crystallized vapor deposited material. A replication tool includes: a tool body that includes a tooling surface; and a structured surface on the tooling surface, wherein the structured surface includes crystallized vapor deposited material or a replica of crystallized vapor deposited material. US 2004/0026832 A1 by Gier et al published 20040212 describes an embossing method for producing a microstructured surface relief. Such molded or embossed microstructured surfaces typically have fractal or random surface structures having sizes in the nanometer to tens of microns range. Applicants have constructed surfaces having micro-replicated fractal-like features varying in size from 20 to 100 nm using the injection roll molding manufacturing process described above in polycarbonate and polyester materials.

Alternatively, random microstructured roughness on the peaks of the integral spacer dots having similar feature sizes in the nanometer to tens of microns range may be created by abrasive mechanical means such as sandblasting, abrasive water jet, rubbing with sandpaper or abrasive, and the like. It would also be possible to prepare a microstructured rough surface by adding material onto an originally manufactured smooth surface, such as by adhering grains of particulate matter of a suitable size using a suitable adhesive. Such coatings or abrading can be performed using rollers in contact with the peaks of the integral compressible spacer dots only.

The adhesion properties of the peaks of the integral compressible spacer dots may be further controlled by depositing additional material selectively on the peaks, for example with a roller 90, or an inkjet device (not shown). Such materials may comprise, e.g., polymers that have very low surface energy. Examples of such polymers may be taken from classes of polymers including fluorocarbons, perfluorocarbons, polysiloxanes and mixtures thereof. For example, TEFLON™ (polytetrafluoroethylene) is a widely-known and available hydrophobic material with low surface energy. These polymers, if employed, should be deposited at thicknesses that will ensure that the fractal-like or random features produced via the micro-replication or abrasive processes are maintained. Thus, these polymers will serve only to further minimize wettability of the integral spacer dot peaks.

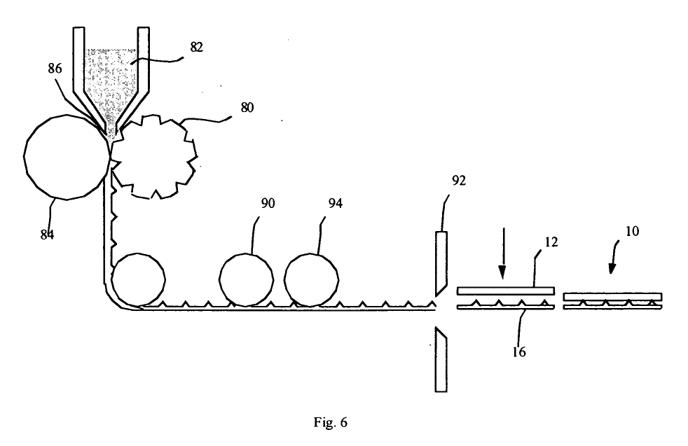

Next, a conductive layer coating is applied 94 on the flexible cover sheet, over and between the integral spacer dots. Because the peaks of the integral compressible spacer dots have microstructured structures, the coating does not adhere to the peaks of the dots. Hence, once the conductive coating is in place, no conductive material is located on or near the peaks of the integral compressible spacer dots. FIG. 7 illustrates the effect. Referring to FIG. 7, a flexible cover sheet 16 has a conductive coating 18 and an integral spacer dot 50 with microstructures on the peak 55. Conductive coating 18 does not extend over the microstructures on the peak 55. Suitable coating methods including curtain coating, roll coating and spin coating, slide coating, ink jet printing, patterned gravure coating, blade coating, electro-photographic coating and centrifugal coating may be used to apply the conductive coating. The conductive coating may typically have a sheet resistivity of between 100 and 600 ohms/square. To further facilitate coating of the conductive layer only between the spacer beads, a low viscosity conductive material may be used which flows primarily into the spaces between the spacer dots, leaving the peaks exposed. The conductive material viscosity is preferably less than 4 mPa.sec, although the use of a microstructured peak surface may allow the use of higher viscosity materials if desired. The surface on which the conductive material is deposited can be pre-treated for improved adhesion by any of the means known in the art, such as acid etching, flame treatment, corona discharge treatment, glow discharge treatment or can be coated with a suitable primer layer. However, corona discharge treatment is the preferred means for adhesion promotion. The coating may then be dried or cured to form a conductive layer with localized areas on the peaks of the integral compressible spacer dots lacking any conductive coating.

In preferred embodiments, the conductive layer is transparent, and may be formed, e.g., from materials which include indium tin oxide, antimony tin oxide, electrically conductive polymers such as substituted or unsubstituted polythiophenes, substituted or unsubstituted polypyrroles, single-wall carbon nanotubes, and substituted or unsubstituted polyanilines. Preferred electrically conducting polymers for the present invention include polypyrrole styrene sulfonate (referred to as polypyrrole/poly (styrene sulfonic acid) in U.S. Pat. No. 5,674,654), 3,4-dialkoxy substituted polypyrrole styrene sulfonate, and 3,4-dialkoxy substituted polythiophene styrene sulfonate. The most preferred substituted electronically conductive polymers include poly(3,4-ethylene dioxythiophene styrene sulfonate).

As further illustrated in FIG. 6, the web of transparent flexible cover sheet material with integral spacer dots may then be cut 92 into individual cover sheets 16, and applied to a substrate 12 of a touch screen 10.

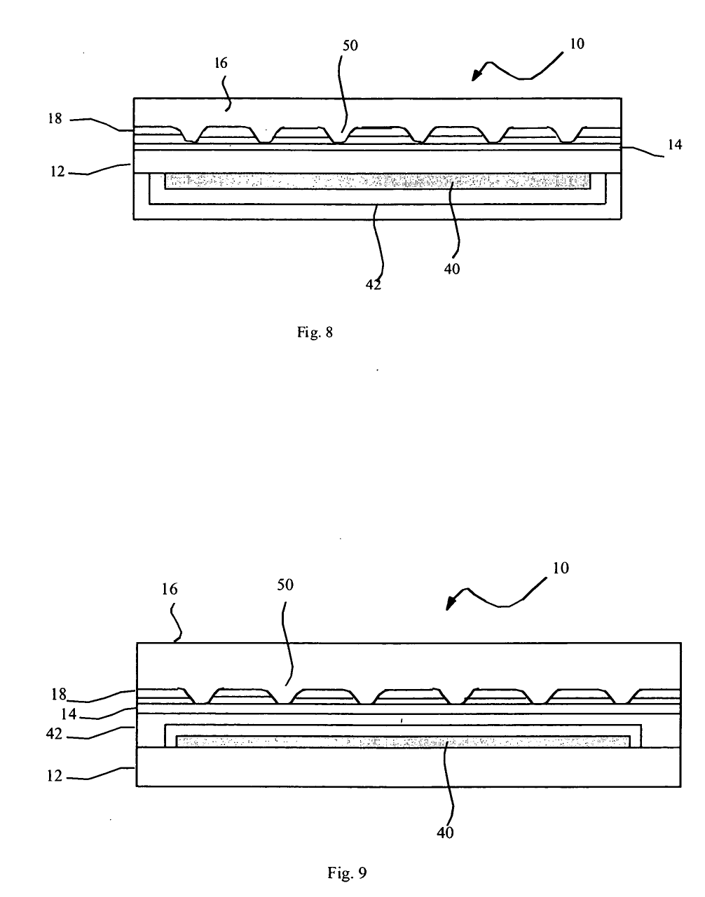

Referring to FIGS. 8 and 9, the touch screen of the present invention can be integrated into a flat-panel display by using either the cover or the substrate of the flat-panel display as the transparent substrate 12 of the touch screen. The flat-panel display may emit light through a transparent cover or through a transparent substrate. As shown in FIG. 8, a flat-panel OLED display with an integrated touch screen includes a substrate 12, OLED materials 40 and encapsulating cover 42 for the OLED display. On the opposite side of the substrate 12, the touch screen includes the first conductive layer 14 and the flexible transparent cover sheet 16 having a second conductive layer 18 and integral compressible spacer dots 50.

As shown in FIG. 9, an OLED display with an integrated touch screen includes a substrate 12, OLED materials 40, and an encapsulating cover 42 for the OLED display. On the opposite side of the encapsulating cover 42, the touch screen includes the first conductive layer 14 and the flexible transparent cover sheet 16 having a second conductive layer 18 and integral compressible spacer dots 50.

The number of features per area is determined by the spacer dot size and the pattern depth. Larger diameters and deeper patterns require fewer numbers of features in a given area. Therefore the number of features is inherently determined by the spacer dot size and the pattern depth. The spacer dots of the invention may also be manufactured by vacuum forming around a pattern, injection molding the dots and embossing dots in a polymer web. While these manufacturing techniques do yield acceptable dots, injection roll molding polymer onto a patterned roller allows for the flexible cover sheet with spacer dots of the invention to be formed into rolls thereby lowering the manufacturing cost.

Injection roll molding has been shown to more efficiently replicate the desired complex dot geometry compared to embossing and vacuum forming. It is further contemplated that the flexible cover sheet is cut into the desired size for application to an LCD or OLED flat-panel display, for example.

The present invention may be used in conjunction with any flat panel display, including but not limited to OLED and liquid crystal display devices.

The entire contents of the patents and other publications referred to in this specification are incorporated herein by reference.

The invention has been described in detail with particular reference to certain preferred embodiments thereof, but it will be understood that variations and modifications can be effected within the spirit and scope of the invention.

### PARTS LIST

10 resistive touch screen
12 substrate
13 finger
14 first conductive layer
16 cover sheet
18 second conductive layer
20 spacer dot
40 OLED materials
42 encapsulating cover
50 integral compressible spacer dot
55 microstructured area
80 patterned roller
82 polymer
84 backing roller
86 nip
90 application roller
92 cut step
94 conductive layer application roller

1. A resistive touch screen, comprising:
a) a substrate;
b) a first conductive layer located on the substrate;
c) a flexible cover sheet comprising a substantially planar surface and integral compressible spacer dots formed thereon, each integral compressible spacer dot having a base closest to the planar surface and a peak furthest from the planar surface, with a microstructured surface on the peak of each of the integral compressible spacer dots; and
d) a second conductive layer located on the flexible cover sheet, the peaks of the integral compressible spacer dots extending through the second conductive layer, whereby, when a force is applied to the flexible transparent cover sheet at the location of one of the compressible spacer dots, the compressible spacer dot is compressed to allow electrical contact between the first and second conductive layers.

2. The resistive touch screen of claim 1, wherein the substrate, first conductive layer, flexible cover sheet, and second conductive layer are transparent.

3. The resistive touch screen of claim 2, wherein the substrate is rigid.

4. The resistive touch screen claimed in claim 1, wherein the substrate of the touch screen is the substrate or cover of a flat-panel display device.

5. The resistive touch screen claimed in claim 4, wherein the flat-panel display device is an OLED display device.

6. The resistive touch screen of claim 1, wherein said flexible cover comprises one of the group including: polymer, polyolefin polymer, polyester, polycarbonate, and a blend of polyester and polycarbonate.

7. The resistive touch screen of claim 1, wherein said integral compressible spacer dots comprise cylinder-shaped dots, cube-shaped dots, pyramid-shaped dots, or sphere-shaped dots.

8. The resistive touch screen of claim 1, wherein said substrate comprises a rigid material.

9. The resistive touch screen of claim 1, wherein the second conductive layer comprises an electrically conductive polymer.

10. The resistive touch screen of claim 9, wherein the conductive layer comprises one of the group including polypyrrole styrene sulfonate, 3,4-dialkoxy substituted polypyrrole styrene sulfonate, and 3,4-dialkoxy substituted polythiophene styrene sulfonate, poly(3,4-ethylene dioxythiophene styrene sulfonate.

11. The resistive touch screen of claim 9, wherein the conductive layer comprises polythiophine.

12. A method of making a resistive touch screen, comprising the steps of:
a) providing a substrate;
b) forming a first conductive layer on the substrate;
c) providing a flexible cover sheet comprising a substantially planar surface and integral compressible spacer dots formed thereon, each integral compressible spacer dot having a base closest to the planar surface and a peak furthest from the planar surface, with a microstructured surface on the peak of each of the integral compressible spacer dots;
d) forming a second conductive layer on the flexible cover sheet between the integral compressible spacer dots by coating a conductive material over the flexible cover sheet such that the microstructured surface of the integral compressible spacer dot peaks do not wet and are not covered with the second conductive layer; and
e) locating the flexible cover sheet over the substrate such that when a force is applied to the flexible cover sheet at the location of one of the integral compressible spacer dots, the integral compressible spacer dot is compressed to allow electrical contact between the first and second conductive layers.

13. The method claimed in claim 12, wherein the flexible cover sheet is provided as a web in a continuous roll, the integral spacer dots are molded with microstructured surface peaks in the continuous roll, and the sheet is cut from the roll.

14. The method claimed in claim 12, wherein the integral spacer dots having microstructured surface peaks are formed in the flexible cover sheet by injection roll molding.

15. The method claimed in claim 12, wherein the spacer dots having microstrucured surface peaks are formed in the flexible cover sheet by applying heat and pressure to the flexible cover sheet by a mold including a reverse image of the spacer dots.

16. The method of claim 12, wherein the second conductive layer comprises an electrically conductive polymer.

17. The method claimed in claim 12, wherein the microstructured surface is embossed into the peak of the integral compressible spacer dot.

18. The method claimed in claim 12, wherein the microstructured surface is formed by abrading the peak of the integral compressible spacer dot.

19. The method claimed in claim 12, wherein the microstructured surface is formed by adhering grains of particulate matter to the peak of the integral compressible spacer dot.
